(19) United States
(12) Patent Application Publication
(10) Pub. No.: US 2017/0217833 A1
(43) Pub. Date: Aug. 3, 2017

(54) TRANSPARENT SUBSTRATE WITH COATING FILM

(71) Applicant: ASAHI GLASS COMPANY, LIMITED, Chiyoda-ku (JP)

(72) Inventors: Hirokazu KODAIRA, Chiyoda-ku (JP); Takashige YONEDA, Chiyoda-ku (JP)

(73) Assignee: ASAHI GLASS COMPANY, LIMITED, Chiyoda-ku (JP)

(21) Appl. No.: 15/417,552

(22) Filed: Jan. 27, 2017

(30) Foreign Application Priority Data
Feb. 1, 2016 (JP) 2016-017103

(51) Int. Cl. C03C 17/02

(52) U.S. Cl. CPC C03C 17/02; C03C 2217/213; C03C 2217/74; C03C 2217/78; C03C 2218/113

(57) ABSTRACT

Provided is a transparent substrate with a coating film having excellent ultraviolet absorbing ability and scratch resistance while maintaining visible light transmittance at high level. The transparent substrate with the coating film includes a transparent substrate, and a coating film formed at least at a part of a surface of the transparent substrate. The coating film contains a silicon oxide matrix and a specific ultraviolet absorbent, and has a thickness of 3 to 10 μm. The transparent substrate with the coating film has a transmittance of light with a wavelength of 400 nm of 10% or less, and a visible light transmittance of 50% or more, no scratch is visually recognized by a specific scratch resistance test for surface of the coating film, and a value where YI of the transparent substrate is subtracted from YI of the transparent substrate with the coating film is 10 or less.

### CROSS REFERENCE TO RELATED APPLICATION

This application is based upon and claims the benefit of priority from the prior Japanese Patent Application No. 2016-017103, filed on Feb. 1, 2016; the entire contents of which are incorporated herein by reference.

### FIELD

The present invention relates to a transparent substrate with a coating film, and particularly to a transparent substrate with a coating film having excellent ultraviolet absorbency and scratch resistance while maintaining high visible light transmittance.

### BACKGROUND

Conventionally, on a transparent substrate such as window glass for vehicles such as automobiles and window glass for building materials to be attached to architectures such as houses and buildings, an ultraviolet absorbing film having the ability to absorb ultraviolet rays entering the vehicle or the building through such a substrate and having mechanical durability such as abrasion resistance has been attempted to be formed.

For example, there is described a substrate with a stacked film which has a resin layer containing an ultraviolet absorbent and a protective film whose main constituent is a silicon oxide-based matrix formed thereon on the substrate in Patent Reference 1 (International Publication WO2010/140688). There is also described in Patent Reference 1 an art to make the ultraviolet absorbent contain in the protective film.

In the substrate with the stacked film described in Patent Reference 1, the high visible light transmittance and the excellent ultraviolet absorbency are both enabled. In particular, it is enabled to reduce transmittance of light with a wavelength of 400 nm, but there is the resin layer, and therefore, mar resistance when it is scratched with a tip having high hardness such as a penpoint, so-called scratch resistance is not always sufficient.

Besides, in Patent Reference 2 (International Publication WO 2010/131744), there are described an application solution for forming an ultraviolet-absorbing film containing a silylated ultraviolet absorbent, an epoxy group containing organooxysilane compound, and organooxysilane compounds other than the above as raw materials of a silicon oxide-based matrix, and an ultraviolet-absorbing glass article having the ultraviolet-absorbing film formed by the application solution.

In the ultraviolet-absorbing glass article in Patent Reference 2, the scratch resistance is sufficient, the visible light transmittance is sufficiently high, and the light with the wavelength of 380 nm or less can be sufficiently absorbed regarding the ultraviolet absorbency, but it is not to sufficiently reduce the transmittance of light with the wavelength of 400 nm. This is because when the ultraviolet absorbent capable of sufficiently reduce the transmittance of the light with the wavelength of 400 nm which is contained in the resin layer in Patent Reference 1 is used for the silicon oxide-based matrix, sufficiently high visible light transmittance cannot be obtained if a content of the ultraviolet absorbent becomes large enough to sufficiently reduce the transmittance of the light with the wavelength of 400 nm.

As stated above, if one property is satisfied, the other property is sacrificed, and a coating film capable of reducing the transmittance of the light with the wavelength of 400 nm while satisfying the scratch resistance cannot be enabled.

### SUMMARY

The present invention is made from the above-described viewpoints, and an object thereof is to provide a transparent substrate with a coating film having both excellent ultraviolet absorbing ability and scratch resistance while maintaining visible light transmittance at high level.

A transparent substrate with a coating film according to the present invention includes: a transparent substrate; and a coating film formed on at least part of a surface of the transparent substrate, wherein the coating film contains a silicon oxide matrix, an azomethine-based ultraviolet absorbent, and one kind or more selected from a benzophenone-based ultraviolet absorbent, a triazine-based ultraviolet absorbent, and a benzotriazole-based ultraviolet absorbent, a thickness of the coating film is 3.0 μm to 10.0 μm, the transparent substrate with the coating film has a transmittance of light with a wavelength of 400 nm of 10% or less, and a visible light transmittance (Tvₐ) measured according to JIS 83212 (1998) of 50% or more, no scratch is visually recognized by a scratch resistance test where a surface of the coating film is scratched for 2 cm at a rate of 10 cm/min with a ballpoint pen having a diameter of 1.0 mm in the state that a load of 9.8 N is applied to the surface by pressing the ballpoint pen thereto, and a value (ΔYI) where an yellow index (YI_{b}) of the transparent substrate is subtracted from an yellow index (YIₐ) of the transparent substrate with the coating film measured based on JIS Z8722 (2009) is 10 or less.

According to the present invention, it is possible to provide a transparent substrate with a coating film having both excellent ultraviolet absorbing ability and scratch resistance while maintaining visible light transmittance at high level.

### DETAILED DESCRIPTION

Hereinafter, embodiments of the present invention are described.

A transparent substrate with a coating film of the present invention includes a transparent substrate and a coating film which is formed on at least part of a surface of the transparent substrate and has a constitution described below, and all of properties of the following (1), (2), (3), and (4) are satisfied.
The coating film contains a silicon oxide matrix, an azomethine-based ultraviolet absorbent (hereinafter, called also as an ultraviolet absorbent (a1)), and one kind or more selected from a benzophenone-based ultraviolet absorbent, a triazine-based ultraviolet absorbent, and a benzotriazole-based ultraviolet absorbent (hereinafter, called also as an ultraviolet absorbent (a2)), and a thickness thereof is 3.0 to 10.0 μm.

(1) The transparent substrate with the coating film has a transmittance of light with a wavelength of 400 nm of 10% or less.

(2) The transparent substrate with the coating film has a visible light transmittance (Tvₐ) measured according to JIS 83212 (1998) of 50% or more.

(3) No scratch is visually recognized by a scratch resistance test where a surface of the coating film is scratched for 2 cm at a rate of 10 cm/min with a ballpoint pen having a diameter of 1.0 mm in the state that a load of 9.8 N is applied to the surface by pressing the ballpoint pen thereto (hereinafter, it is also called just as a “scratch resistance test”).

(4) A value (ΔYI) where an yellow index (YI_{b}) of the transparent substrate is subtracted from an yellow index (YIₐ) of the transparent substrate with the coating film measured based on JIS Z8722 (2009) is 10 or less.

The transparent substrate with the coating film of the present invention preferably satisfies any one of or two or more of the following properties of (5) to (15) in combination in addition to satisfy all of the above-stated (1) to (4). Note that the following (5) to (10) are the properties of the transparent substrate with the coating film, and the (11) and (12) represent the properties of the coating film in the transparent substrate with the coating film. The (13) to (15) represent the properties of the transparent substrate in the transparent substrate with the coating film.

(5) The transparent substrate with the coating film has a ultraviolet transmittance measured according to ISO-13837 (2008) of 1.0% or less.

(6) The transparent substrate with the coating film has the yellow index (YIₐ) measured based on JIS Z8722 (2009) of 18 or less.

(7) The transparent substrate with the coating film has a haze value (Hₐ) of 1.0% or less.

(8) When an abrasion resistance test with a CS-10F abrasion wheel at a load of 4.9 N and 1000 rotations by JIS 83212 (1998) (hereinafter, it is called also as an abrasion test (A)) is performed for the surface of the coating film, an increased amount of the haze value (ΔH_{abrasion}) of the transparent substrate with the coating film after the test relative to before the test is 5.0% or less.

(9) When a weather resistance test where the transparent substrate with the coating film is placed in a sunshine weather meter and exposed to conditions of an irradiance of 78.5 W/m² (light with the wavelength of 300 to 400 nm), a black panel temperature of 83° C. and a humidity of 50 RH % for 1000 hours (hereinafter, it is also called as a weather resistance test (B)) is performed, an increased amount of the ultraviolet transmittance (ΔTuv_{weather}) measured according to ISO-13837 (2008) of the transparent substrate with the coating film after the test relative to before the test is 4.0% or less.

(10) When a humidity resistance test where the transparent substrate with the coating film is left under conditions of 80° C. and 95 RH % for 500 hours (hereinafter, it is also called as a humidity resistance test (C)) is performed, an increased amount of the ultraviolet transmittance (ΔTuv_{humidity}) measured according to ISO-13837 (2008) of the transparent substrate with the coating film after the test relative to before the test is 3.0% or less.

(11) A value (ΔTv) where the visible light transmittance (Tvₐ) of the transparent substrate with the coating film is subtracted from visible light transmittance (Tv_{b}) of the transparent substrate measured according to JIS R3212 (1998) is 1.5% or less.

(12) A value (All) where a haze value (H_{b}) of the transparent substrate is subtracted from the haze value (IL) of the transparent substrate with the coating film is 0.5% or less.

(13) The transparent substrate in the transparent substrate with the coating film has the yellow index (YI_{b}) measured based on JIS Z8722 (2009) of 18 or less.

(14) The transparent substrate in the transparent substrate with the coating film has the visible light transmittance (Tv_{b}) of the transparent substrate measured based on JIS 83212 (1998) of 70% or more.

(15) The transparent substrate in the transparent substrate with the coating film has the ultraviolet transmittance measured according to ISO-13837 (2008) of 1.0% or less.

Here, abbreviations of respective physical properties in the transparent substrate with the coating film and the transparent substrate in itself used in this description are illustrated in Table 1. Besides, abbreviations of physical properties used for evaluation of various endurance tests performed for the transparent substrate with the coating film are illustrated in Table 2.

TABLE 1

| | | Abbreviation | | |
|---|---|---|---|---|
| | | Transparent | | Difference |
| | | substrate with | Transparent | (value of |
| Physical property [unit] | Standard | coating film | substrate | coating film) |
| Transmittance of light with | — | Tuvₐ₄₀₀ | Tuv_{b400} | |
| wavelength of 400 nm [%] | | | | |
| Ultraviolet transmittance | ISO-13837 (2008) | Tuvₐ | Tuv_{b} | |
| (Tuv) [%] | | | | |
| Visible light transmittance | JIS R3212 (1998) | Tvₐ | Tv_{b} | ΔTv = Tv_{b} − Tvₐ |
| (Tv) [%] | | | | |
| Yellow index (YI) | JIS Z8722 (2009) | YIₐ | YI_{b} | ΔYI = YIₐ − YI_{b} |
| Haze value (H) [%] | — | Hₐ | H_{b} | ΔH = Hₐ − H_{b} |

TABLE 2

| | | Abbreviation | | |
|---|---|---|---|---|
| | Evaluation physical | Initial | After | |
| Test | property | value | test | Evaluation |
| Abrasion | Haze value (H) [%] | Hₐ | Hₐₐ | ΔH_{abrasion} = Hₐₐ − Hₐ |
| resistance test (A) | | | | |
| Weather | Ultraviolet transmittance | Tuvₐ | Tuv_{aw} | ΔTuv_{weather} = Tuv_{aw} − Tuvₐ |
| resistance test (B) | (Tuv) [%] | | | |
| Humidity | Ultraviolet transmittance | Tuvₐ | Tuvₐₕ | ΔTuv_{humidity} = Tuvₐₕ − Tuvₐ |
| resistance test (C) | (Tuv) [%] | | | |

In the transparent substrate with the coating film of the present invention, the Tuvₐ₄₀₀ is used as an index which attempts to gain absorption performance of ultraviolet rays near a visible light region. In the present invention, when the TUVₐ₄₀₀ is suppressed to be 10% or less, the transparent substrate with the coating film is evaluated to have high ultraviolet absorbing ability. In the transparent substrate with the coating film of the present invention, the Tuvₐ₄₀₀ is 10% or less, and the Tvₐ, is 50% or more. When the Tvₐ is 50% or more, it is evaluated to have sufficient visible light transmittance. In the transparent substrate with the coating film of the present invention, no scratch is visually recognized at the coating film by the scratch resistance test in addition to the above-stated optical properties. Namely, the transparent substrate with the coating film of the present invention has sufficient scratch resistance. The coating film of the transparent substrate with the coating film of the present invention is a coating film where the ΔYE can be set to 10 or less. An external appearance of the transparent substrate with the coating film is easy to be adjusted in good state by using the coating film whose ΔYI can be set to 10 or less.

The Tuvₐ₄₀₀ of the transparent substrate with the coating film of the present invention is preferably 6.0% or less, and particularly preferably 1.0% or less. The Tvₐ of the transparent substrate with the coating film is preferably 70% or more, and particularly preferably 75% or more. The ΔYI of the transparent substrate with the coating film is preferably 5 or less.

In the transparent substrate with the coating film of the present invention, the Tuvₐ is preferably 1.0% or less, and more preferably 0.5% or less. When the Tuvₐ is 1.0% or less, it is preferable because the transparent substrate with the coating film has high ultraviolet absorbency in a whole ultraviolet wavelength region. In the transparent substrate with the coating film of the present invention, the YIₐ is preferably 18 or less, and more preferably 15 or less. When the YIₐ is 18 or less, a color tone of the transparent substrate with the coating film is preferable because yellow tint thereof is suppressed.

In the transparent substrate with the coating film of the present invention, the Hₐ is preferably 1.0% or less, and more preferably 0.6% or less. When the Hₐ is 1.0% or less, it is preferable because the transparent substrate with the coating film is seldom frosted, and has high transparency.

In the transparent substrate with the coating film of the present invention, the ΔH_{abrasion} when the abrasion resistance test (A) is performed for the surface of the coating film is preferably 5.0% or less, and more preferably 4.0% or less. Besides, the ΔTuv_{weather} when the weather resistance test (B) is performed for the transparent substrate with the coating film is preferably 4.0% or less, and more preferably 1.0% or less. Further, the ΔTuv_{humidity} when the humidity resistance test (C) is performed for the transparent substrate with the coating film is preferably 3.0% or less, and more preferably 1.0% or less. When the ΔH_{abrasion} is 5.0% or less, the transparent substrate with the coating film is preferable because high abrasion resistance is held. Besides, when the ΔTuv_{weather} is 4.0% or less, the transparent substrate with the coating film is preferable because high weather resistance is held in the ultraviolet absorbing ability. Further, when the ΔTuv_{humidity} is 3.0% or less, the transparent substrate with the coating film is preferable because high humidity resistance is held in the ultraviolet absorbing ability.

Hereinabove, the properties (1) to (10) of the transparent substrate with the coating film of the present invention are described. Each component constituting the transparent substrate with the coating film of the present invention having the above-stated properties is described below together with properties thereof.

The transparent substrate with the coating film of the present invention includes the transparent substrate and the coating film having the above-stated composition (hereinafter, it is called just as a “coating film”) formed on at least part of the surface of the transparent substrate. An area where the coating film is formed on the surface of the transparent substrate is not particularly limited, and it may be formed at a required area according to need. The area where the coating film is formed may be, for example, on one principal surface or on both principal surfaces of a plate-shaped transparent substrate.

<Transparent Substrate>

The transparent substrate is not particularly limited as long as all of the properties of the above-stated (1) to (4) are satisfied as the transparent substrate with the coating film together with the later-described coating film. As the properties of the transparent substrate, it is preferable to satisfy any one of or two or more properties in combination from among the (13) to (15) properties.

The YI_{b} of the transparent substrate is preferably 18 or less, and more preferably 9 or less. When the YI_{b} is 18 or less, it is easy to achieve the YIₐ of 18 or less in the obtained transparent substrate with the coating film. The Tv_{b} of the transparent substrate is preferably 70% or more, and more preferably 73% or more. When the Tv_{b} is 70% or more, it is easy to achieve the Tvₐ of 50% or more in the obtained transparent substrate with the coating film.

The H_{b} of the transparent substrate is preferably 0.5% or less, and more preferably 0.1% or less. When the H_{b} is 0.5% or less, it is easy to achieve the Hₐ of 1.0% or less in the obtained transparent substrate with the coating film.

A material and a shape of the transparent substrate are not particularly limited as long as it is a substrate which is visually recognized to be transparent. A substrate satisfying the YI_{b} of 18 or less, the Tv_{b} of 70% or more, and the H_{b} of 0.5% or less can be said to be a substrate which is substantially visually recognized to be transparent.

Further, the Tuv_{b} of the transparent substrate is preferably 27% or less, and more preferably 25% or less. When the Tuv_{b} is 27% or less, it is easy to achieve the Tuvₐ of 1.0% or less, and the Tuvₐ₄₀₀ of 10% or less in the obtained transparent substrate with the coating film.

As the material of the transparent substrate which can be used for the transparent substrate with the coating film of the present invention, there can be cited a transparent glass, a resin, and so on. As the glass, specifically, there can be cited a normal soda lime glass, an aluminosilicate glass, a borosilicate glass, a non-alkali glass, a quartz glass, and so on. As the glass, a glass absorbing ultraviolet-rays and/or infrared-rays can also be used. Besides, as the resin, there can be cited an acrylic-based resin such as polymethyl methacrylate, an aromatic polycarbonate-based resin such as polyphenylene carbonate, a polystyrene resin, and so on. The transparent substrate is preferably a glass substrate.

The shape of the transparent substrate may be a flat plate, or may have a curvature at a whole surface or a part thereof. A thickness of the transparent substrate can be appropriately selected according to purposes of the transparent substrate with the coating film. The thickness is preferably a thickness satisfying the YI_{b} and/or the Tv_{b} when the transparent substrate with the coating film is produced by using the transparent substrate. In general, the thickness is preferably 1 to 10 mm. Besides, the transparent substrate may be a laminated glass where a plurality pieces of glass plates are adhered with a resin intermediate film therebetween.

<Coating Film>

In the transparent substrate with the coating film of the present invention, the coating film contains the silicon oxide matrix, the ultraviolet absorbent (a1), and the ultraviolet absorbent (a2), and a thickness thereof is 3.0 to 10.0 μm. In addition, when the coating film is formed on at least part of the surface of the transparent substrate to be the transparent substrate with the coating film, all of the properties of the (1) to (4) are satisfied. As the properties of the coating film, either one of the properties of the (11), (12), or two properties in combination are preferably satisfied.

The coating film is preferably a coating film that the ΔTv can be set to 1.5% or less, and more preferably 1.0% or less. The coating film that the ΔTv can be set to 1.5% or less is used, and thereby, it is easy to achieve the Tvₐ in the obtained transparent substrate with the coating film of 50% or more.

Similarly, in the present invention, the coating film is preferably a coating film that the ΔH can be set to 0.5% or less, and more preferably 0.3% or less. The coating film that the ΔH can be set to 0.5% or less is used, and thereby, it is easy to achieve the Hₐ in the obtained transparent substrate with the coating film of 1.0% or less.

In the transparent substrate with the coating film of the present invention, the coating film has the ultraviolet absorbing ability by containing the ultraviolet absorbent (a1) and the ultraviolet absorbent (a2), and has the scratch resistance by containing the silicon oxide matrix as a film-forming component. The coating film generally has a constitution where the ultraviolet absorbent (a1) and the ultraviolet absorbent (a2) are dispersed in the silicon oxide matrix as the film-forming component. The coating film may consist of only the matrix and the ultraviolet absorbent, or may contain other additives other than the ultraviolet absorbent.

The coating film is preferably a single layer film. The thickness of the coating film is a thickness capable of achieving the properties of the (1) to (4) in the transparent substrate with the coating film of the present invention which has the coating film containing the above-stated components, namely, it is 3.0 to 10.0 μm. The thickness of the coating film is preferably 4.0 to 7.0 μm. The coating film may be formed at one principal surface or both principal surfaces of the transparent substrate.

Note that the film thickness of the coating film is a film thickness represented as an average film thickness. A minimum film thickness of the coating film is preferably 1.0 μm or more.

The coating film has a structure where the silicon oxide matrix forms a three-dimensional matrix by an Si—O—Si bond, and the ultraviolet absorbent (a1) and the ultraviolet absorbent (a2) are dispersed to be held in the matrix. Note that the coating film in the transparent substrate with the coating film is normally formed by preparing a liquid composition where components constituting the coating film in themselves or raw materials thereof are added to a solvent, and by using the liquid composition.

Hereinafter, each component of the coating film is described while the ultraviolet absorbent containing the ultraviolet absorbent (a1) and the ultraviolet absorbent (a2) is set as an ultraviolet absorbent (a) or a component (a), and the silicon oxide matrix is set as a silicon oxide matrix (b) or a component (b).

Regarding the silicon oxide matrix (b), a hydrolyzable silane compound (Rb) which is cured to form the silicon oxide matrix is compounded into the liquid composition as a main constituent. The hydrolyzable silane compound (Rb) forms a siloxane bond by a hydrolysis and condensation reaction during the formation of the coating film, is cured to be a hydrolyzable silane compound cured product (b1). The silicon oxide matrix (b) may be constituted only by the hydrolyzable silane compound cured product (b1), may further contain silicon oxide fine particles (b2) in addition to the hydrolyzable silane compound cured product (b1), or may contain a flexible component (b3) in addition to the silicon oxide component.

In the description, the “hydrolyzable silane compound” is used as a term including an unreacted hydrolyzable silane compound, a partially hydrolyzed condensate of one kind thereof, and a partially hydrolyzed co-condensate of two or more kinds, unless otherwise noted. When a specific “hydrolyzable silane compound” is stated, for example, when it is stated as a hydrolyzable silane compound (x), it is used as a term including the unreacted hydrolyzable silane compound (x), the partially hydrolyzed condensate thereof and a unit of the hydrolyzable silane compound (x) in the partially hydrolyzed co-condensate with other hydrolyzable silane compounds. Besides, a term of a (metha)acryloxy group used in the description is a term meaning both an “acryloxy group” and a “methacryloxy group”.

There are cases for example when the ultraviolet absorbent (a) is compounded into the liquid composition as it is and when a silylated ultraviolet absorbent (Ra) having reactivity with the hydrolyzable silane compound (Rb) is compounded as a raw material component of the ultraviolet absorbent (a).

(Ultraviolet Absorbent (a))

The ultraviolet absorbent (a) contains the ultraviolet absorbent (a1) and the ultraviolet absorbent (a2). The azomethine-based ultraviolet absorbent being the ultraviolet absorbent (a1) has a property capable of strongly absorbing the light with the wavelength of around 400 nm (hereinafter, referred to as “400 nm absorbency”), and a property having high solubility with a raw material of the matrix component of the coating film, a component required for the reaction thereof, and a solvent having high compatibility with them (hereinafter, referred to as “matrix compatibility”).

The azomethine-based ultraviolet absorbent has the 400 nm absorbency, and thereby, it is possible to achieve the Tuvₐ₄₀₀ of 10% or less of the transparent substrate with the coating film by being combined with the ultraviolet absorbent (a2), and it has the matrix compatibility, and thereby, it is possible to achieve the Tvₐ of 50% or more of the transparent substrate with the coating film. The matrix compatibility is a property capable of being dissolved in a silicon oxide matrix raw material, water required for the hydrolysis thereof, and a polar solvent having high compatibility with water.

The azomethine-based ultraviolet absorbent is a compound where a hydrocarbon group is bonded to a nitrogen atom. One kind of the azomethine-based ultraviolet absorbent may be used independently, or two or more kinds may be used together.

As the azomethine-based ultraviolet absorbent, specifically, there can be cited BONASORB UA-3701 (product name, manufactured by Orient Chemical Industries Co., Ltd.) represented in the following formula (I), Azomethine-H (product name, manufactured by Nacalai Tesque, inc.) and so on, and BONASORB UA-3701 is particularly preferable in points that the matrix compatibility, the weather resistance, and heat resistance are high, and visible light absorbency (YI) is low.

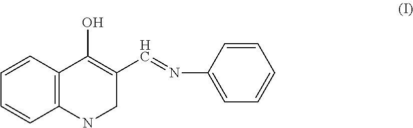 [SMILES: OC1=C(/C=N/c2ccccc2)CNc2ccccc21]

In the present invention, the ultraviolet absorbent (a2) is used together with the ultraviolet absorbent (a1) so as to bring the above-stated optical properties to the transparent substrate with the coating film. Note that the ultraviolet absorbent (a2) has the matrix compatibility as same as the ultraviolet absorbent (a1).

The ultraviolet absorbent (a2) is composed of one kind or more selected from the benzophenone-based ultraviolet absorbent, the triazine-based ultraviolet absorbent, and the benzotriazole-based ultraviolet absorbent. The azomethine-based ultraviolet absorbent and one kind or more selected from the benzophenone-based ultraviolet absorbent, the triazine-based ultraviolet absorbent, and the benzotriazole-based ultraviolet absorbent are combined, and thereby, the properties of the Tvₐ of 50% or more, the Tuvₐ₄₀₀ of 10% or less, and the ΔYI of 10 or less are imparted to the transparent substrate with the coating film. In addition, it becomes thereby possible to impart the property of the Tuvₐ of 1.0% or less to the transparent substrate with the coating film.

As the benzotriazole-based ultraviolet absorbent, specifically, there can be cited 2-[5-chloro(2H)-benzotriazole-2-yl]-4-mehyl-6-(tert-butyl)phenol (TINUVIN 326 (product name, manufactured by BASF Japan Co., Ltd.) or the like as a commercial product), octyl-3-[3-tert-4-hydroxy-5-[5-chloro-2H-benzotriazole-2-yl]propionate, 2-(2H-benzotriazole-2-yl)-4,6-di-tert-pentylphenol, 2-(2-hydroxy-5-methylphenyl)benzotriazole, and so on. Among them, 2-[5-chloro(2H)-benzotriazole-2-yl]-4-mehyl-6-(tert-butyl)phenol is preferably used.

As the triazine-based ultraviolet absorbent, specifically, there can be cited 2-[4-[2-hydroxy-3-dodecyloxypropyl)oxy]-2-hydroxyphenyl]-4,6-bis(2,4-dimethylphenyl)-1,3,5-triazine, 2,4-bis(2-hydroxy-4-butoxyphenyl)-6-(2,4-bis-butoxyphenyl)-1,3,5-triazine, 2-(2-hydroxy-4-[1-octylcarbonylethoxy]phenyl)-4, 6-bis(4-phenylphenyl)-1,3,5-triazine, TINUVIN477 (product name, manufactured by BASF Japan Co., Ltd.), and so on.

Among them, 2-(2-hydroxy-4-[1-octylcarbonylethoxy]phenyl)-4,6-bis(4-phenylphenyl)-1,3,5-triazine is preferably used.

As the benzophenone-based ultraviolet absorbent, specifically, there can be cited 2,4-dihydroxybenzophenone, 2,2′,3 (or any of 4, 5, 6)-trihydroxybenzophenone, 2,2′,4,4′-tetrahydroxybenzophenone, 2,4-dihydroxy-2′,4′-dimethoxybenzophenone, 2-hydroxy-4-n-octoxybenzophenone, and so on. Among them, 2,2′,4,4′-tetrahydroxybenzophenone is preferably used.

As the ultraviolet absorbent (a2), a hydroxy group-containing benzophenone-based compound is preferably used from among the above-exemplified compounds because the solubility to the solvent is high and an absorption wavelength band is in a desired range.

In the present invention, regarding the ultraviolet absorbent (a1) and the ultraviolet absorbent (a2), one kind may be used independently, or two or more kinds may be used together respectively. The ultraviolet absorbent (a) contained in the coating film may further contain an ultraviolet absorbent other than the ultraviolet absorbent (a1) and the ultraviolet absorbent (a2) according to need.

The ultraviolet absorbent (a) contained in the coating film is basically a compound as it is compounded into the liquid composition to form the coating film. Namely, the ultraviolet absorbent (a) compounded into the liquid composition does not take part in the reaction or the like in the process forming the coating film.

A content of the ultraviolet absorbent (a) in the coating film is preferably 5 to 40 parts by mass, more preferably 10 to 30 parts by mass, and particularly preferably 15 to 20 parts by mass relative to 100 parts by mass of the silicon oxide matrix (b) from points that the coating film has sufficient ultraviolet absorbing ability and mechanical strength is secured.

A content of the ultraviolet absorbent (a1) and the ultraviolet absorbent (a2) in the ultraviolet absorbent (a) as a total amount is preferably 50 to 100 mass %, and more preferably 100 mass %. A composition of the ultraviolet absorbent (a) in the coating film is set to be in the above-stated range, and thereby, the optical properties of the Tuvₐ₄₀₀ of 10% or less, the Tvₐ of 50% or more, and the ΔYI of 10 or less are easily achieved in the transparent substrate with the coating film having the coating film with the film thickness of 3.0 to 10.0 μm.

The ultraviolet absorbent (a) can be compounded into the liquid composition as, for example, a reactive ultraviolet absorbent where a hydrolyzable silyl group which has reactivity with a hydrolyzable group held by the hydrolyzable silane compound (Rb) is introduced into the ultraviolet absorbent (a) so as to prevent bleedout from the coating film. Hereinafter, the ultraviolet absorbent composed of the compound containing the silyl group having the hydrolyzable group is called as a silylated ultraviolet abrorbent (Ra). The silylated ultraviolet absorbent (Ra) is used, and thereby, the bleedout of the ultraviolet absorbent (a) from the coating film is suppressed, and improvement in the weather resistance, the humidity resistance, and so on of the ultraviolet absorbing ability held by the coating film can be expected.

It is preferable that the introduction of the silyl group having the hydrolyzable group into the ultraviolet absorbent (a1) and the ultraviolet absorbent (a2) is performed through a hydroxy group held by these ultraviolet absorbents.

When the liquid composition contains the silylated ultraviolet absorbent (Ra) as a raw material component of the ultraviolet absorbent (a), a content may be adjusted such that an amount calculated as stated below becomes the above-described content of the ultraviolet absorbent (a) in the coating film.

Namely, an amount of the silyl group having the hydrolyzable group in the silylated ultraviolet absorbent (Ra) is expressed in terms of SiO₂, and is contained in an amount of the later-described silicon oxide matrix (b). An amount of a part other than the silyl group having the hydrolyzable group in the silylated ultraviolet absorbent (Ra) is regarded as the content of the ultraviolet absorbent (a). Parts by mass of the ultraviolet absorbent (a) relative to 100 parts by mass of the silicon oxide matrix (b) is thereby calculated.

(Silicon Oxide Matrix (b))

The silicon oxide matrix (b) contained in the coating film is mainly composed of the cured product (b1) of the hydrolyzable silane compound (Rb), and the silicon oxide fine particles (b2) and/or the flexible component (b3) are contained according to need. A content of the hydrolyzable silane compound cured product (b1) in the silicon oxide matrix (b) is preferably 50 to 100 mass %, and more preferably 60 to 95 mass % though it depends on a kind of the hydrolyzable silane compound (Rb).

An amount of the hydrolyzable silane compound cured product (b1) contained in the coating film can be calculated from a content of the hydrolyzable silane compound (Rb) in the liquid composition. The content of the hydrolyzable silane compound (Rb) in the liquid composition is an SiO₂ content relative to a total amount of solid contents in the composition when silicon atoms contained in the hydrolyzable silane compound (Rb) is expressed in terms of SiO₂. In the description, the content of the hydrolyzable silane compound cured product (b1) in the coating film is a content of the hydrolyzable silane compound (Rb) expressed in terms of SiO₂ relative to the total amount of the solid contents of the liquid composition unless otherwise noted.

The content of the silicon oxide matrix (b) is preferably 5 to 90 mass %, and more preferably 10 to 85 mass % relative to a total mass of the coating film. The silicon oxide matrix (b) is contained in the above-stated range, and thereby, strength of the coating film becomes sufficient owing to formation of a silica network.

As the hydrolyzable silane compound (Rb), there can be cited a compound (Rb1) represented by the following formula (Rb1).

R^{H1}ₙ₁SiX¹₄₋ₙ₁ (Rb1)

In the formula (Rb1), n1 is an integer from “0” (zero) to 3, R^{H1} is a substituted or unsubstituted hydrocarbon group having 1 to 20 carbon atoms which does not have a fluorine atom, and X¹ is the hydrolyzable group. When there are a plurality of R^{H1} and X¹, they may be different or the same.

The compound (Rb1) contains monofunctional to tetrafunctional hydrolyzable silane compounds where the number of hydrolyzable groups (X¹) represented by “4−n1” is 1 to 4. As the compound (Rb1), one kind may be used independently or two or more kinds may be used together. When one kind of the compounds (Rb1) is used independently, normally, trifunctional or tetrafunctional hydrolyzable silane compound is used to form the three dimensional siloxane bond. When two or more kinds are used together as the compounds (Rb1), the monofunctional hydrolyzable silane compound and/or the bifunctional hydrolyzable silane compound may be used in addition to the trifunctional and/or tetrafunctional hydrolyzable silane compound.

As the hydrolyzable group (X¹) held by the compound (Rb1), specifically, an organooxy group such as an alkoxy group, an alkenyloxy group, an acyloxy group, an iminoxy group, an aminooxy group are preferable, and the alkoxy group is particularly preferable. As the alkoxy group, the alkoxy group having 1 to 4 carbon atoms and an alkoxy-substituted alkoxy group having 2 to 4 carbon atoms (2-methoxyethoxy group or the like) are preferable, and the methoxy group and the ethoxy group are particularly preferable.

The tetrafunctional hydrolyzable silane compound is represented by SiX¹₄. As SiX¹₄, specifically, there can be cited tetramethoxysilane, tetraethoxysilane, tetra-n-propoxysilane, tetra-n-butoxysilane, tetra-sec-buthoxysilane, tetra-tert-buthoxysilane, and so on. In the present invention, tetraethoxysilane, tetramethoxysilane, and so on are preferably used. One kind of them may be used independently, or two or more kinds may be used together.

The trifunctional hydrolyzable silane compound is a compound where three hydrolyzable groups (X¹) and one R^{H1} are bonded to the silicon atom. The three hydrolyzable groups may be the same or different. When the R^{H1} is the unsubstituted hydrocarbon group, an alkyl group, aryl group and the like having 1 to 10 carbon atoms are preferable, and the alkyl group having 1 to 4 carbon atoms is particularly preferable.

As the trifunctional hydrolyzable silane compound where the R^{H1} is the unsubstituted hydrocarbon group, specifically, there can be cited methyltrimethoxysilane, methyltriethoxysilane, methyltris(2-methoxyethoxy)silane, methyltriacetoxysilane, methyltri-n-propoxysilane, methyltriisopropenoxysilane, methyltri-n-butoxysilane, ethyltrimethoxysilane, ethyltriethoxysilane, phenyltrimethoxysilane, phenyltriethoxysilane, phenyltriacetoxysilane, and so on. One kind of them may be used independently, or two or more kinds may be used together.

As a substituent which may be held by the R^{H1}, there can be cited an epoxy group, a (metha)acryloxy group, a primary or secondary amino group, an oxetanyl group, a vinyl group, a styryl group, an ureido group, a mercapto group, an isocyanate group, a cyano group, a halogen atom, and so on. The epoxy group, the (metha)acryloxy group, the primary or secondary amino group, the oxetanyl group, the vinyl group, the ureido group, the mercapto group, and so on are preferable. The epoxy group, the primary or secondary amino group, the (metha)acryloxy group are particularly preferable.

As a group having the epoxy group, a glycidoxy group, a 3,4-epoxycyclohexyl group are preferable and as the primary or secondary amino group, an amino group, a monoalkylamino group, a phenylamino group, an N-(aminoalkyl)amino group, and so on are preferable.

As the trifunctional hydrolyzable silane compound where the R^{H1} is the substituted hydrocarbon group, specifically, there can be cited 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-methacryloxypropyltrimethoxysilane, di-(3-methacryloxy)propyltriethoxysilane, and so on. From a point of reactivity with the silane compound, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, and so on are particularly preferable. One kind of them may be used independently, or two or more kinds may be used together.

The hydrolyzable silane compound (Rb) is preferably composed of (I) only the tetrafunctional hydrolyzable silane compound, or by (II) the tetrafunctional hydrolyzable silane compound and the trifunctional hydrolyzable silane compound. In the present invention, it is particularly preferably composed of (I) only the tetrafunctional hydrolyzable silane compound. Note that in case of (I), the coating film preferably contains further the later-described flexible component (b3) so as to obtain sufficient crack resistance while securing, in particular, a predetermined thickness. Besides, in case of (II), a content ratio between the tetrafunctional hydrolyzable silane compound and the trifunctional hydrolyzable silane compound is preferably 30/70 to 95/5, more preferably 40/60 to 90/10, and particularly preferably 50/50 to 85/15 in mass ratio when expressed in the tetrafunctional hydrolyzable silane compound/trifunctional hydrolyzable silane compound.

Besides, the bifunctional hydrolyzable silane compound is optionally used in (I) and (II) according to need. A content thereof is preferably an amount of 30 mass % or less in mass % relative to a total amount of the hydrolyzable silane compound (Rb).

Here, the hydrolyzable silane compound (Rb) is preferably composed of the compound at least a part thereof is partially hydrolyzed and (co)condensed compared to a case when it is composed of only the unreacted hydrolyzable silane compound, namely, a monomer of the hydrolyzable silane compound in points of stability and a uniform reaction of the hydrolyzable silane compound in the liquid compound. It is therefore preferable that the hydrolyzable silane compound (Rb) is compounded into the liquid composition as the partially hydrolyzed condensate of the hydrolyzable silane compound (Rb) (monomer) or the hydrolyzable silane compound (Rb) (monomer) is mixed with the other components contained in the liquid composition, and thereafter, at least a part thereof is partially hydrolyzed and condensed to be the liquid composition.

The partially hydrolyzed (co)condensate is an oligomer (multimer) generated by the hydrolyzable silane compound which is hydrolyzed and then dehydrated and condensed. The partially hydrolyzed (co)condensate is normally a high molecular weight substance in a degree capable of dissolving in a solvent. The partially hydrolyzed (co)condensate has the hydrolyzable group or a silanol group, and has a property to be a final cured product by further hydrolyzed and (co)condensed. The partially hydrolyzed condensate can be obtained from only a certain kind of hydrolyzable silane compound, or the partially hydrolyzed co-condensate being a co-condensate of two or more kinds of hydrolyzable silane compounds can be obtained from the two or more kinds thereof.

The partial hydrolysis and (co-)condensation of the hydrolyzable silane compound can be performed by, for example, stirring a reaction solution where water is added to a lower alcohol solution of the hydrolyzable silane compound at 10 to 70° C. for 1 to 48 hours in the presence of an acid catalyst. As the acid catalyst used in the reaction, specifically, there can be exemplified: inorganic acids such as nitric acid, hydrochloric acid, sulfuric acid, and phosphoric acid; carboxylic acids such as formic acid, acetic acid, propionic acid, glycolic acid, oxalic acid, malonic acid, succinic acid, maleic acid, phthalic acid, citric acid, and malic acid; and sulfonic acids such as methanesulfonic acid.

An addition amount of the acid can be set without being particularly limited in a range where the acid can fulfill the function as the catalyst, and specifically, can be set to about 0.001 to 3.0 moles/L as an amount relative to a volume of the reaction solution containing the hydrolyzable silane compound.

The silicon oxide matrix (b) optionally contains the silicon oxide fine particles (b2). It is possible to improve the abrasion resistance of the coating film by containing the silicon oxide fine particles (b2) depending on a composition of the silicon oxide matrix (b).

When the silicon oxide fine particles (b2) are compounded into the liquid composition as the silicon oxide matrix (b), it is preferably compounded as colloidal silica. Note that colloidal silica is one where the silicon oxide fine particles (b2) are dispersed in water or an organic solvent such as methanol, ethanol, isobutanol, and propylene glycol monomethyl ether. Besides, when the partially hydrolyzed (co)condensate of the hydrolyzable silane compound (Rb) is produced, the partial hydrolysis and (co-)condensation is performed by compounding colloidal silica into a raw material hydrolyzable silane compound to thereby obtain the hydrolyzable (co)condensate containing the silicon oxide fine particles, and it is also possible to make the liquid composition containing the silicon oxide fine particles (b2) by using the above.

Besides, when the silicon oxide matrix (b) contains the silicon oxide fine particles (b2), a content thereof is preferably such an amount to be 0.5 to 10 parts by mass, and more preferably 1 to 5 parts by mass relative to 100 parts by mass of a total amount of the hydrolyzable silane compound (Rb). The above-stated range of the content is the content range of the silicon oxide fine particles (b2) capable of keeping film-forming ability of the coating film while securing sufficient scratch resistance and abrasion resistance, and preventing occurrence of cracks and lowering of transparency of the coating film due to aggregation of the silicon oxide fine particles, in the coating film formed by using the liquid composition.

The flexible component (b3) can contribute to suppressing the occurrence of cracks in the coating film. In particular, when the hydrolyzable silane compound (Rb) is composed of only the tetrafunctional hydrolyzable silane compound, flexibility of the coating film is not sufficient in some cases. If the liquid composition contains the flexible component (b3) together with the tetrafunctional hydrolyzable silane compound, it is possible to easily produce the coating film excellent both in the mechanical strength and the crack resistance.

As the flexible component (b3), there can be cited, for example, various kinds of organic resins such as a silicone resin, an acrylic resin, a polyester resin, a polyurethane resin, a hydrophilic organic resin containing a polyoxyalkylene group, and an epoxy resin, and an organic compound such as glycerin.

When the organic resin is used as the flexible component (b3), the organic resin is preferably in a liquid form, a fine particle form, or the like. The organic resin may also be a curable resin that cures together with the curing of the hydrolyzable silane compound (Rb) by heating when the coating film is formed using the liquid composition containing this organic resin. In this case, a part of the hydrolyzable silane compound (Rb) and the curable resin being the flexible component (b3) may partially react to be cross-linked to an extent not hindering the properties of the obtained coating film.

As the hydrophilic organic resin containing the polyoxyalkylene group in the flexible components (b3), there can be preferably cited polyethylene glycol (PEG) and polyether phosphate ester-based polymer, and so on.

When the epoxy resin is used as the flexible component (b3), it is preferable that a combination of polyepoxides and a curing agent is used, or polyepoxides are independently used. Polyepoxides are a generic term for compounds having a plurality of epoxy groups. Namely, an average number of epoxy groups of the polyepoxides is 2 or more, and in the present invention, polyepoxides whose average number of epoxy groups is 2 to 10 are preferable.

As such polyepoxides, a polyglycidyl eter compound is preferable, and an aliphatic polyglycidyl eter compound is particularly preferable. As the polyglycidyl ether compound, the glycidyl ether of bifunctional or higher functional alcohol is preferable, and the glycidyl ether of trifunctional or higher functional alcohol is particularly preferable because it can improve light resistance. These alcohols are preferably aliphatic alcohols, alicyclic alcohols, or sugar alcohols.

As the polyglycidyl ether compound, polyglycidyl ether (having more than two glycidyl groups (epoxy groups) per molecule on average) of aliphatic polyol having three or more hydroxy groups such as glycerol polyglycidyl ether, diglycerol polyglycidyl ether, polyglycerol polyglycidyl ether, and sorbitol polyglycidyl ether are preferable because they can improve particularly the light resistance. One kind of them may be used independently or two or more kinds may be used together.

In the present invention, among the flexible components (b3), the epoxy resin, in particular, polyepoxides, PEG, glycerin, and the like are preferable because they can impart sufficient flexibility to the coating film while maintaining mechanical strength. Moreover, the epoxy resin, in particular, polyepoxides, PEG, glycerin, and the like not only have a function of preventing the occurrence of cracks caused by long-term light irradiation but also have a function of suppressing deterioration of various functions such as ultraviolet absorption and infrared absorption while maintaining colorless transparency of the coating film. Note that in the present invention, polyepoxides are particularly preferable among them.

A content of the flexible component (b3) in the coating film is not particularly limited, as long as it is possible to impart flexibility to the obtained coating film to improve crack resistance without impairing the effect of the present invention, and this content is preferably such an amount to be 0.1 to 100 parts by mass, more preferably 1.0 to 50 parts by mass relative to 100 parts by mass of the hydrolyzable silane compound (Rb).

(Optional Components)

The coating film in the transparent substrate with the coating film of the present invention may optionally contain functional components, for example, an infrared absorbent (c) other than the ultraviolet absorbent (a). As other components, the coating film may further contain additives such as a surface modifier, a defoamer, and a viscosity modifier for the purpose of improving coatability of the liquid composition, and may contain additives such as an adhesion-imparting agent for the purpose of improving adhesion to the surface of the substrate. Compounding amounts of these additives are preferably such amounts that each of the additive components becomes 0.01 to 2 parts by mass relative to 100 parts by mass of the silicon oxide matrix (b). Further, the coating film may contain a dye, a pigment, a filler, and so on in a range not impairing the object of the present invention.

(Formation of Coating Film: Manufacture of Transparent Substrate with Coating Film)

There can be cited a method including for example the following step (A) to step (C) as a method of forming the coating film containing the above-stated various components on the surface of the transparent substrate in order to obtain the transparent substrate with the coating film of the present invention when the matrix component is the silicon oxide matrix (b).

(A) A liquid composition preparing step of preparing the liquid composition which contains the ultraviolet absorbent (a) containing the ultraviolet absorbent (a1) and the ultraviolet absorbent (a2) and the silicon oxide matrix (b) component as the essential components and the optional components which are used according to need, as they are or as their raw material components, and further contains the solvent;

(B) An applied film forming step of forming the applied film by applying the liquid composition on the film-formation surface of the transparent substrate; and

(C) A curing step of removing volatile components such as the solvent from the obtained applied film according to need, and heating the applied film to a temperature where the hydrolyzable silane compound mainly composed of the hydrolyzable silane compound (Rb) cures, to cure the applied film.

(A) Liquid Composition Preparing Step

The liquid composition contains, as its solid content, the ultraviolet absorbent (a) or the reactive ultraviolet absorbent (Ra) (in the description below, the term “ultraviolet absorbent (a)” includes the reactive ultraviolet absorbent (Ra)) and the silicon oxide matrix (b) which mainly contains the hydrolyzable silane compound (Rb) as the raw material component, being the essential components, and further contains the optional components, with their contents being appropriately adjusted in the above-described ranges.

In order to apply the above components uniformly on the transparent substrate, the liquid composition is a composition which is prepared in the liquid form by adding the solvent to these components. Contents of the components relative to the total solid content in the liquid composition correspond to the contents of the components in the coating film.

(Solvent)

As the solvent, the liquid composition normally contains water for hydrolyzing the hydrolyzable silane compound (Rb) or the like, and an organic solvent. The organic solvent means: a solvent which is compatible with water and where the components such as the ultraviolet absorbent (a), the hydrolyzable silane compound (Rb), and the flexible component (b3) are dissolved; and dispersion media where solid fine particles such as the silicon oxide fine particles (b2), the infrared absorbent (c) are dispersed, and it is an organic compound with a relatively low boiling point which takes on a liquid form at room temperature. The organic solvent is composed of an organic compound such as alcohol, and may be a mixture of two or more kinds.

Further, the dispersion medium and the solvent may be the same organic solvent, or may be different organic solvents. In case where the dispersion medium and the solvent are different, the organic solvent in the liquid composition is a mixture of these dispersion medium and solvent. In this case, the dispersion medium and the solvent are a combination compatible with each other so that the mixture becomes the homogeneous mixture.

In case when the compounded components such as the ultraviolet absorbent (a), the hydrolyzable silane compound (Rb), the flexible component (b3), the silicon oxide fine particles (b2), and the infrared absorbent (c) are provided in a state of a solution or a dispersion liquid, the solvent and the dispersion medium may be used as they are as a part of the organic solvent or water of the liquid composition without being removed.

A content of water in the liquid composition is calculated as an amount including an amount of water thus added together with the various components in addition to an amount of water that is added independently. The amount of water contained in the liquid composition is not particularly limited as long as it is an amount large enough to hydrolyze and (co)condense the contained hydrolyzable silane compound. Specifically, this amount is preferably such an amount that its molar ratio becomes 1 to 20 equivalents, more preferably 4 to 18 equivalents relative to an amount expressed in terms of SiO₂ of the contained hydrolyzable silane compound. When the amount of water is less than 1 equivalent in terms of the molar ratio, the hydrolysis is difficult to progress, and the liquid composition may be repelled when applied on some substrates, or haze may increase. When the amount of water exceeds 20 equivalents, a hydrolysis rate becomes fast, and long-term storability may become insufficient.

As the organic solvent, specifically, there can be cited: ketones such as acetone, methyl ethyl ketone, methyl isobutyl ketone, and cyclohexanone; ethers such as tetrahydrofuran, 1,4-dioxane, 1,2-dimethoxyethane, and propylene glycol monomethyl ether; esters such as ethyl acetate, butyl acetate, and isobutyl acetate; alcohols such as methanol, ethanol, 1-propanol, 2-propanol, 1-butanol, 2-butanol, 2-methyl-1-propanol, 2-methoxyethanol, 4-methyl-2-pentanol, 2-butoxyethanol, 1-methoxy-2-propanol, 2-ethoxyethanol, and diacetone alcohol; hydrocarbons such as n-hexane, n-heptane, isoctane, benzene, toluene, and xylene; acetonitrile, nitromethane, and so on.

These each may be used independently, or two or more kinds may be used together. Further, an amount of the organic solvent used is appropriately adjusted according to the kinds, the compounding ratios, and so on of the various components contained in the liquid composition as the solid contents.

In order to obtain a state where the components contained in the liquid composition are stably dissolved or dispersed, the organic solvent contains at least 20 mass % or more, preferably 50 mass % or more of alcohol. As the alcohol used in such organic solvent, methanol, ethanol, 1-propanol, 2-propanol, 1-butanol, 2-butanol, 2-methyl-1-propanol, 1-methoxy-2-propanol, 2-ethoxyethanol, 4-methyl-2-pentanol, and 2-butoxyethanol, and so on are preferable.

Among them, alcohol whose boiling point is 80 to 160° C. is preferable because the silicon oxide matrix raw material component is highly soluble therein and it has good coatability on the substrate. Specifically, ethanol, 1-propanol, 2-propanol, 1-butanol, 2-butanol, 2-methyl-1-propanol, 1-methoxy-2-propanol, 2-ethoxyethanol, 4-methyl-2-pentanol, and 2-butoxyethanol are preferable. Further, for example, 1-methoxy-2-propanol, 2-ethoxyethanol, and so on are preferable from a viewpoint of, for example, the solubility of the ultraviolet absorbent (a), in particular, the solubility of the azomethine-based compound.

When water and alcohol are combined, a combination of water and 1-methoxy-2-propanol is preferable.

For example, when the partially hydrolyzed (co)condensate of the hydrolyzable silane compound is contained, lower alcohol or the like which is produced in its manufacturing process in accordance with the hydrolysis of the raw material hydrolyzable silane compound (for example, silanes having the alkoxy group), or alcohol or the like used as the solvent may be contained as it is as the organic solvent used in the liquid composition.

Further, in the liquid composition, other organic solvents other than alcohol miscible with a mixture of water and alcohol, may be used together as an organic solvent other than the above, and as the organic solvent as stated above, there can be cited: ketones such as acetone and acetylacetone; esters such as ethyl acetate and isobutyl acetate; and ethers such as propylene glycol monomethyl ether, dipropylene glycol monomethyl ether, and diisopropyl ether.

An amount of the solvent contained in the liquid composition is preferably such an amount that a total solid content concentration in the liquid composition composed of the solvent and the solid content becomes 3.5 to 50 mass %, and more preferably 9 to 30 mass %. Setting the amount of the solvent in the liquid composition in the range improves workability.

It is possible to prepare the liquid composition by uniformly mixing the components including the solvent. A mixing method is not particularly limited as long as a method capable of uniformly mixing. Specifically, there can be cited a mixing method by using a magnetic stirrer or the like.

In mixing the liquid composition, when the hydrolyzable silane compound such as the hydrolyzable silane compound (Rb) is prepared as the monomer, the mixing is preferably performed under a condition causing the hydrolyzable silane compound to be partially hydrolyzed and (co)condensed. It is normally possible to achieve the purpose by mixing one kind or more of the hydrolyzable silane compound monomers according to need and thereafter stirring them at 10 to 70° C. for a predetermined time in the presence of the acid catalyst.

The mixing of the liquid composition may be performed by a method of partially hydrolyzing and (co)condensing the hydrolyzable silane compound in the solvent and adding the other components such as the ultraviolet absorbent (a) to the obtained solution, or by a method of partially hydrolyzing and (co)condensing the hydrolyzable silane compound in the presence of the components other than the infrared absorbent (c) and thereafter compounding a dispersion liquid of the infrared absorbent (c).

(B) Applied Film Forming Step

The liquid composition obtained in the above-described step (A) is applied on the film-formation surface of the transparent substrate to form the applied film of the liquid composition in the step (B). Note that the applied film formed here is normally an applied film containing volatile components such as the organic solvent and water. A method of applying the liquid composition on the transparent substrate is not particularly limited as long as it is a method capable of uniform application, and there can be used any of known methods such as a flow coating method, a dip coating method, a spin coating method, a spray coating method, a flexographic printing method, a screen printing method, a gravure printing method, a roll coating method, a meniscus coating method, and a die coating method. A thickness of the applied film of the application solution is determined in consideration of the thickness of the finally obtained coating film.

(C) Curing Step

The step (C) performed next is performed under an appropriate condition selected according to the kind of the hydrolyzable silane compound such as the used hydrolyzable silane compound (Rb). That is, in the step (C), the volatile components such as the organic solvent and water are removed from the applied film of the liquid composition on the transparent substrate according to need, and the hydrolyzable silane compound and other curable components if contained, are heated and cured, whereby the coating film as the cured film is formed.

In this case, the removal of the volatile components from the applied film in the step (C) is preferably performed by heating and/or pressure-reduced drying. The formation of the applied film on the transparent substrate is preferably followed by temporary drying at a temperature of about room temperature to 120° C. from a viewpoint of improving a leveling property of the applied film. Normally, since the volatile components are usually removed by vaporization simultaneously with the temporary drying during the operation of this temporary drying, it can be said that the operation for removing the volatile components is included in the temporary drying. A time of the temporary drying, namely, a time of the operation for removing the volatile components is preferably about 3 seconds to 2 hours, though depending on the liquid composition used to form the coating film.

At this time, the volatile components are preferably sufficiently removed, but are not necessary to be completely removed. Namely, a part of the volatile components can remain in the coating film in a range not affecting the performance of the finally obtained coating film. Further, when the heating is performed to remove the volatile components, the heating for removing the volatile components, that is, generally the temporary drying, may be continuously followed by heating performed thereafter in the following manner to cure the hydrolyzable silane compound and the other curable components if contained.

The curable components such as the hydrolyzable silane compound are cured by heating preferably after the volatile components are removed from the applied film as described above, whereby the coating film is obtained. An upper limit of a heating temperature in this case is preferably 230° C. from a viewpoint of economic efficiency and because the applied film contains organic substances in many cases. In order to obtain an effect of accelerating the reaction by the heating, a lower limit of the heating temperature is preferably 80° C. A heating time is preferably several minutes to several hours, though depending on the composition of the liquid composition used to form the coating film.

Hereinabove, the manufacturing method of the transparent substrate with the coating film of the present invention is described, and the manufacturing method is not limited thereto as long as the transparent substrate with the coating film satisfying all of the properties of the (1) to (4) can be obtained. The transparent substrate with the coating film of the present invention satisfies all of the properties of the (1), (2), (3), and (4), namely, it is the transparent substrate with the coating film where the visible light transmittance is maintained at high level, and the excellent ultraviolet absorbing ability and the scratch resistance are both held. Accordingly, it is possible to apply for outdoor glass articles, for example, a window glass for vehicles such as an automobile and a window glass for building materials attached to architectures such as a house and a building, and so on.

### EXAMPLES

Hereinafter, the present invention will be further described by citing examples, but the present invention is not limited to these examples. In the following description, examples 1 to 4 are the examples and examples 5 to 7 are comparative examples.

<Details of Commercial Products (Product Names) Used in Examples>

(Ultraviolet Absorbent (a1))
BONASORB UA-3701 (product name): manufactured by Orient Chemical Industries Co., Ltd., the azomethine-based compound represented in the formula (I)
(Ultraviolet Absorbent other than ultraviolet absorbent (a1) and ultraviolet absorbent (a2)) BONASORB UA-3911 (product name): manufactured by Orient Chemical Industries Co., Ltd., an indole-based compound (hereinafter, referred to as “ultraviolet absorbent (ax)”)
(Silicon Oxide Fine Particles (b2))
Methanol silica sol: manufactured by Nissan Chemical Industries, Ltd., colloidal silica where silica fine particles whose mean primary particle diameter is 10 to 20 nm is dispersed in methanol at a solid content concentration of 30 mass %

### (Solvent)

Solmix AP-1 (product name): manufactured by Japan Alcohol Trading Co., Ltd., a mixed solvent of ethanol:isopropyl alcohol:methanol=85.5:13.4:1.1 (mass ratio)
(Flexible Component (b3))
SR-SEP (product name): manufactured by Sakamoto Yakuhin Kogyo Co., Ltd., sorbitol-based polyglycidyl ether

### Example 1

In a container, 2.68 g of Solmix AP-1, 1.19 g of tetramethoxysilane, 2.11 g of water, 1.12 g of acetic acid, 0.69 g of 3-glycidoxypropyltrimethoxysilane, 0.27 g of 2,2′,4,4′-tetrahydroxybenzophenone (manufactured by BASF Co., Ltd.) as the ultraviolet absorbent (a2), 0.02 g of BONASORB UA-3701, 1.33 g of 1-methoxy-2-propanol, 0.09 g of SR-SEP, 0.17 g of methanol silica sol (0.05 g as a solid content) were prepared and stirred for one hour, whereby a liquid composition 1 for forming the coating film was obtained.

Thereafter, the liquid composition 1 was applied on highly heat-absorbing green glass plate (Tv_{b}: 73.5%, Tuv_{b}: 23.3%, 10 cm in vertical, 10 cm in horizontal, 3.5 mm in thickness, manufactured by Asahi Glass Co., Ltd., popular name of UVFL) whose surface was washed, by the spin coating method, and heated at 140° C. in the atmosphere for 30 minutes, whereby a glass plate with a coating film 1 was obtained. Properties of the obtained glass plate with the coating film 1 were evaluated as follows. Table 3 shows the evaluation results together with the compositions of the coating film. Note that a content of the hydrolyzable silane compound cured product (b1) in Table 3 shows a total amount expressed in terms of SiO₂ of tetramethoxysilane and 3-glycidoxypropyltrimethoxysilane.

[Evaluation]

1) Film thickness: Cross section observation of the coating film was performed by a scanning electron microscope (manufactured by Hitachi, Ltd.: S-800), to obtain a film thickness [μm] from an obtained observation image.
2) Spectral characteristics were calculated based on transmittance with wavelength of 300 to 800 nm measured by using a spectrophotometer (manufactured by Hitachi, Ltd.: U-4100). A measurement value as it was used regarding the transmittance of light with the wavelength of 400 nm. The ultraviolet transmittance (Tuv) was calculated according to ISO-13837 (2008). The visible light transmittance (Tv) was calculated according to JIS R3212 (1998).
3) Haze value: Measured by using a haze meter (manufactured by BYK Gardner Co., Ltd.: Haze Guard Plus).
4) Yellow index (YI): Measured by using the spectrophotometer (manufactured by Hitachi, Ltd.: U-4100) according to JIS Z8722 (2009).
5) Abrasion resistance: An abrasion resistance test was performed for the coating film of the obtained glass plate with coating film 1 by using a Taber abrasion resistance tester according to the method described in JIS R3212 (1998), with a CS-10F abrasion wheel, at a 4.9 N load, and 1000 rotations, and degrees of scratches before and after the test were measured based on the haze values and were evaluated based on an increased amount (ΔH_{abrasion}) [%] of the haze value.
6) Humidity resistance: Evaluated by an increased amount (ΔTuv_{humidity}) of the ultraviolet transmittance of a specimen measured according to ISO-13837 (2008) after a test where the specimen (glass plate with coating film 1) was input to a thermohygrostat at 80° C. and 95 RH %, and 500 hours were elapsed, relative to the ultraviolet transmittance before the test. 7) Weather resistance: Evaluated by an increased amount (ΔTuv_{weather}) of the ultraviolet transmittance of a specimen measured according to ISO-13837 (2008) after a test when there was performed a weather resistance test where the specimen (glass plate with coating film 1) was placed in a sunshine weather meter, and exposed to conditions of an irradiance of 78.5 W/m² (300 to 400 nm), a black panel temperature of 83° C. and a humidity of 50 RH % for 1000 hours, relative to the ultraviolet transmittance before the test.
8) Scratch resistance (mar resistance/hardness evaluation): Scratch marks were visually judged after a scratch resistance test where a surface of the coating film of the obtained glass plate with coating film 1 was scratched for 2 cm at a rate of 10 cm/min with a ballpoint pen having a diameter of 1.0 mm in the state that a load of 9.8 N was applied to the surface by pressing the ballpoint pen thereto. It was judged to be “x” when scratches were visually recognized, and to be “O” when no scratch was recognized (not at all, seldom exist).

### Example 2

A glass plate with a coating film 2 was produced in the same manner as the example 1 except that a film thickness was changed as illustrated in Table 3. Properties of the obtained glass plate with the coating film 2 were evaluated as in the example 1. Table 3 shows the evaluation results.

### Example 3

A glass plate with a coating film 3 was produced in the same manner as the example 1 except that the glass substrate was changed to a glass plate A (Tv_{b}: 74.9%, Tuv_{b}: 25.3%, 10 cm in vertical, 10 cm in horizontal, 3.5 mm in thickness, manufactured by Asahi Glass Co., Ltd.), and a film thickness was changed as illustrated in Table 3. Properties of the obtained glass plate with the coating film 3 were evaluated as in the example 1. Table 3 shows the evaluation results.

### Example 4

A glass plate with a coating film 4 was produced in the same manner as the example 1 except that the glass substrate was changed to the same glass plate A used in the example 3 and a film thickness was changed as illustrated in Table 3. Properties of the obtained glass plate with the coating film 4 were evaluated as in the example 1. Table 3 shows the evaluation results.

### Example 5

A glass plate with a coating film 5 was produced in the same manner as the example 1 except that a film thickness was changed as illustrated in Table 3. Properties of the obtained glass plate with the coating film 5 were evaluated as in the example 1. Table 3 shows the evaluation results.

### Example 6

A liquid composition 2 for forming a coating film was produced in the same manner as the example 1 except that BONASORB UA-3911 was used instead of BONASORB UA-3701, and a glass plate with a coating film 6 was produced in the same manner as the example 1 by using the liquid composition 2 instead of the liquid composition 1. Properties of the obtained glass plate with the coating film 6 were evaluated as in the example 1. Table 3 shows the evaluation results together with the compositions of the coating film.

### Example 7

A liquid composition 3 for forming a coating film was produced in the same manner as the example 1 except that 2,2′,4,4′-tetrahydroxybenzophenone was not added, and a glass plate with a coating film 7 was produced in the same manner as the example 1 by using the liquid composition 3 instead of the liquid composition 1. Properties of the obtained glass plate with the coating film 7 were evaluated as in the example 1. Table 3 shows the evaluation results together with the compositions of the coating film.

### Example 8

A liquid composition 4 for forming a coating film was produced in the same manner as the example 1 except that BONASORB UA-3701 was not added, and a glass plate with a coating film 8 was produced in the same manner as the example 1 by using the liquid composition 4 instead of the liquid composition 1. Properties of the obtained glass plate with the coating film 8 were evaluated as in the example 1. Table 3 shows the evaluation results together with the compositions of the coating film.

### Example 9

A liquid composition 5 for forming a coating film was produced in the same manner as the example 1 except that the amount of BONASORB UA-3701 was changed to 0.05 g and the amount of 1-methoxy-2-propanol was changed to 3.00 g, and a glass plate with a coating film 9 was produced in the same manner as the example 1 by using the liquid composition 5 instead of the liquid composition 1 with a film thickness illustrated in Table 3. Properties of the obtained glass plate with the coating film 9 were evaluated as in the example 1. Table 3 shows the evaluation results together with the compositions of the coating film.

### Example 10

A liquid composition 6 for forming a coating film was produced in the same manner as the example 1 except that the amount of BONASORB UA-3701 was changed to 0.12 g, and the amount of 1-methoxy-2-propanol was changed to 7.70 g, and a glass plate with a coating film 10 was produced in the same manner as the example 1 by using the liquid composition 6 instead of the liquid composition 1 with a film thickness illustrated in Table 3. Properties of the obtained glass plate with the coating film 10 were evaluated as in the example 1. Table 3 shows the evaluation results together with the compositions of the coating film.

TABLE 3

| | | E1 | E2 | E3 | E4 | E5 | E6 | E7 | E8 | E9 | E10 |
|---|---|---|---|---|---|---|---|---|---|---|---|
| Coating film | Ultraviolet absorbent (a1) | 0.9 | Same as | Same as | Same as | Same as | — | 0.9 | — | 2.0 | 5.0 |
| composition | Ultraviolet absorbent (ax) | — | E1 | E1 | E1 | E1 | 0.9 | — | — | — | — |
| (mass %) | Ultraviolet absorbent (a2) | 11.7 | | | | | 11.7 | — | 11.7 | 11.6 | 11.2 |
| | Hydrolyzable silane | 81.3 | | | | | 81.3 | 89.0 | 82.1 | 80.4 | 78.0 |
| | compound cured product | | | | | | | | | | |
| | (b1) | | | | | | | | | | |
| | SiO₂ fine particles (b2) | 2.2 | | | | | 2.2 | 2.4 | 2.2 | 2.1 | 2.1 |
| | Flexible component (b3) | 3.9 | | | | | 3.9 | 4.3 | 3.9 | 3.9 | 3.7 |
| Initial | Film thickness [μm] | 5.6 | 3.6 | 6.0 | 3.8 | 2.8 | 5.6 | 2.6 | 3.6 | 1.2 | 0.1 |
| value | Tuvₐ₄₀₀[%] | 4.2 | 6.0 | 4.0 | 5.8 | 12.0 | 4.0 | 20.0 | 23.0 | 22.2 | 24.0 |
| | Tv_{b}[%] | 73.5 | 73.5 | 74.9 | 74.9 | 73.5 | 73.4 | 73.5 | 73.5 | 73.6 | 73.6 |
| | Tvₐ[%] | 73.3 | 73.3 | 73.0 | 73.2 | 73.3 | 73.1 | 73.3 | 73.3 | 73.3 | 73.2 |
| | ΔTv[%] = Tv_{b} − Tvₐ | 0.2 | 0.2 | 1.9 | 1.8 | 0.2 | 0.3 | 0.2 | 0.2 | 0.3 | 0.3 |
| | Tuv_{b}[%] | 23.3 | 23.3 | 25.3 | 25.3 | 23.3 | 25.3 | 23.3 | 23.3 | 25.3 | 25.3 |
| | Tuvₐ[%] | 0.3 | 0.8 | 0.2 | 0.4 | 1.6 | 0.2 | 5.9 | 4.0 | 15.0 | 24.0 |
| | YI_{b} | −0.3 | −0.3 | 8.1 | 8.1 | −0.3 | −0.3 | −0.3 | −0.3 | −0.3 | −0.3 |
| | YIₐ | 8.0 | 5.7 | 16.8 | 13.9 | 4.3 | 15.2 | 6.2 | 4.6 | 1.0 | 0.0 |
| | ΔYI = YIₐ − YI_{b} | 8.3 | 6.0 | 8.7 | 5.8 | 4.6 | 15.5 | 6.5 | 4.9 | 1.3 | 0.3 |
| | H_{b}[%] | 0.1 | 0.1 | 0.1 | 0.1 | 0.1 | 0.1 | 0.1 | 0.1 | 0.1 | 0.1 |
| | Hₐ[%] | 0.2 | 0.3 | 0.2 | 0.2 | 0.3 | 0.2 | 0.2 | 0.2 | 0.2 | 0.2 |
| | ΔH[%] = Hₐ − H_{b} | 0.1 | 0.2 | 0.1 | 0.1 | 0.2 | 0.1 | 0.1 | 0.1 | 0.1 | 0.1 |
| | Scratch resistance | ∘ | ∘ | ∘ | ∘ | ∘ | ∘ | ∘ | ∘ | ∘ | ∘ |

| | | | | | | | | | | |
|---|---|---|---|---|---|---|---|---|---|---|
| ΔH_{abrasion}[%] | 3.0 | 2.8 | 3.1 | 3.0 | 3.1 | 2.8 | 3.5 | 2.8 | Peeling | Peeling |
| ΔTuv_{humidity}[%] | 1.5 | 1.4 | 1.6 | 1.5 | 2.0 | 1.6 | 6.5 | 5.0 | 1.0 | 0.5 |
| ΔTuv_{weather}[%] | 0.6 | 3.4 | 0.8 | 3.5 | 8.4 | 0.8 | 25.0 | 12.0 | 10.3 | 1.3 |

E1 to E10 = Example 1 to Example 10

As it can be seen from Table 3, the glass plates with the coating film 1 to 4 according to the examples 1 to 4 where the coating film contains the silicon oxide matrix, the azomethine-based ultraviolet absorbent, and one kind or more selected from the benzophenone-based ultraviolet absorbent, the triazine-based ultraviolet absorbent, and the benzotriazole-based ultraviolet absorbent, and the thickness of the coating film is in the range of 3.0 to 10.0 m are the transparent substrates with the coating film of the present invention where all of the properties of (1) Tuvₐ₄₀₀≦10%, (2) Tvₐ≧50%, (3) the scratch resistance in the 8) is “O”, and (4) ΔYI≦10 are satisfied.

On the other hand, the glass plates with the coating film 5 to 10 according to the examples 5 to 10 do not satisfy the property of the (1) or (4) and are not the transparent substrates with the coating film of the present invention because either the azomethine-based ultraviolet absorbent (ultraviolet absorbent (a1)) or one kind or more selected from the benzophenone-based ultraviolet absorbent, the triazine-based ultraviolet absorbent, and the benzotriazole-based ultraviolet absorbent (ultraviolet absorbent (a2)) is not contained, or the thickness of the coating film is out of the range of 3.0 to 10.0 μm if both of the above are contained.

The glass article of the present invention is the transparent substrate with the coating film which has both excellent ultraviolet absorbing ability and scratch resistance while maintaining visible light transmittance at high level. It is therefore applicable to glass articles for outdoor use, for example, a window glass for vehicles such as an automobiles and a window glass for building materials attached to architectures such as a house and a building, and so on.

What is claimed is:

1. A transparent substrate with a coating film comprising:
a transparent substrate; and
a coating film formed on at least part of a surface of the transparent substrate,
wherein the coating film contains a silicon oxide matrix,
an azomethine-based ultraviolet absorbent, and
one kind or more selected from a benzophenone-based ultraviolet absorbent, a triazine-based ultraviolet absorbent, and a benzotriazole-based ultraviolet absorbent,
a thickness of the coating film is 3.0 μm to 10.0 μm,
the transparent substrate with the coating film has a transmittance of light with a wavelength of 400 nm of 10% or less, and a visible light transmittance (Tvₐ) measured according to JIS R3212 (1998) of 50% or more,
no scratch is visually recognized by a scratch resistance test where a surface of the coating film is scratched for 2 cm at a rate of 10 cm/min with a ballpoint pen having a diameter of 1.0 mm in the state that a load of 9.8 N is applied to the surface by pressing the ballpoint pen thereto, and
a value (ΔYI) where an yellow index (YI_{b}) of the transparent substrate is subtracted from an yellow index (YIₐ) of the transparent substrate with the coating film measured based on JIS Z8722 (2009) is 10 or less.

2. The transparent substrate with the coating film according to claim 1,
wherein a value (ΔTv) where the visible light transmittance (Tvₐ) of the transparent substrate with the coating film is subtracted from a visible light transmittance (Tv_{b}) of the transparent substrate measured according to JIS R3212 (1998) is 1.5% or less.

3. The transparent substrate with the coating film according to claim 1,
wherein when there is performed a weather resistance test where the transparent substrate with the coating film is placed in a sunshine weather meter and exposed to conditions of an irradiance of 78.5 W/m² (300 to 400 nm), a black panel temperature of 83° C. and a humidity of 50 RH % for 1000 hours, an increased amount of the ultraviolet transmittance (ΔTuv_{weather}) of the transparent substrate with the coating film measured according to ISO-13837 (2008) after the test relative to before the test is 4.0% or less.

4. The transparent substrate with the coating film according to claim 1,
wherein when there is performed a humidity resistance test where the transparent substrate with the coating film is left under conditions of 80° C. and 95 RH % for 500 hours, an increased amount of the ultraviolet transmittance (ΔTuv_{humidity}) of the transparent substrate with the coating film measured according to ISO-13837 (2008) after the test relative to before the test is 3.0% or less.

5. The transparent substrate with the coating film according to claim 1,
wherein the coating film is a single layer film.
